(19) United States
(12) Patent Application Publication
(10) Pub. No.: US 2017/0242373 A1
(43) Pub. Date: Aug. 24, 2017

(54) TUBULAR MEMBER, TRANSFER BELT, TRANSFER UNIT, AND IMAGE FORMING APPARATUS

(71) Applicant: FUJI XEROX CO., LTD., Tokyo (JP)

(72) Inventors: Tomoo MATSUSHIMA, Kanagawa (JP); Fumio DAISHI, Kanagawa (JP); Kenji OMORI, Kanagawa (JP)

(73) Assignee: FUJI XEROX CO., LTD., Tokyo (JP)

(21) Appl. No.: 15/229,250

(22) Filed: Aug. 5, 2016

(30) Foreign Application Priority Data
Feb. 18, 2016 (JP) 2016-029173

(51) Int. Cl. B32B 9/04; G03G 15/01

(52) U.S. Cl. CPC G03G 15/162

(57) ABSTRACT

A tubular member includes a siloxane-modified polyetherimide, a polyetherimide except the siloxane-modified polyetherimide, and a conductive material, wherein a content of the siloxane-modified polyetherimide with respect to a total content of the siloxane-modified polyetherimide and the polyetherimide except the siloxane-modified polyetherimide at a surface layer portion is 40% by weight or more.

### CROSS-REFERENCE TO RELATED APPLICATIONS

This application is based on and claims priority under 35 USC 119 from Japanese Patent Application No. 2016-029173 filed Feb. 18, 2016.

### BACKGROUND

### Technical Field

The present invention relates to a tubular member, a transfer belt, a transfer unit, and an image forming apparatus.

### SUMMARY

According to an aspect of the invention, there is provided a tubular member including:

a siloxane-modified polyetherimide;

a polyetherimide except the siloxane-modified polyetherimide; and

a conductive material,

wherein a content of the siloxane-modified polyetherimide with respect to a total content of the siloxane-modified polyetherimide and the polyetherimide except siloxane-modified polyetherimide at a surface layer portion is 40% by weight or more.

### BRIEF DESCRIPTION OF THE DRAWINGS

Exemplary embodiments of the present invention will be described in detail based on the following figures, wherein:

FIG. 1 is a perspective view schematically illustrating an example of a tubular member according to an exemplary embodiment;

FIG. 2 is a perspective view schematically illustrating an example of a transfer unit according to the exemplary embodiment; and

FIG. 3 is a configuration diagram schematically illustrating an example of an image forming apparatus according to the exemplary embodiment.

### DETAILED DESCRIPTION

Hereinafter, description will be given of an exemplary embodiment as an example of the invention with reference to accompanying drawings. In the following description, reference numerals will be omitted in some cases.

### Tubular Member

A tubular member according to the exemplary embodiment includes a siloxane-modified polyetherimide, a polyetherimide except the siloxane-modified polyether imide, and a conductive material, and the content of the siloxane-modified polyetherimide with respect to the total content of the siloxane-modified polyetherimide and the polyetherimide except the siloxane-modified polyetherimide at a surface layer portion is equal to or greater than 40% by weight. In the following description, the polyetherimide except the siloxane-modified polyetherimide will be simply referred to as “polyetherimide”, and the siloxane-modified polyetherimide and the polyetherimide except the siloxane-modified polyetherimide will be collectively referred to as “all the polyetherimide components” in some cases.

Both the surface resistance maintaining property and the cleaning maintaining property are achieved by the tubular belt 10 according to the exemplary embodiment. The reason thereof is considered to be as follows though not clear.

If image formation is repeated in an image forming apparatus provided with a transfer belt that includes a thermoplastic resin and a conductive material, variations in electric resistance (decrease in resistance) of the transfer belt tends to occur due to electric load (load caused by discharging). The decrease in resistance of the transfer belt may cause variations in image density.

In addition, it is necessary to perform cleaning for removing residual toner or foreign matters with a blade, a brush, or the like since residual toner on the transfer belt or adhesion of foreign matters such as discharge product thereto may cause a failure (a streak image defect, for example) in transferring a toner image to a recording medium.

The resistance tends to decrease in a transfer belt using polyetherimide as a thermoplastic resin, for example, and the decrease in resistance tends to further remarkably occur if a conductive material with large particle sizes is used, in particular. Such decrease in resistance of the transfer belt is considered to be caused because a part of polyetherimide included in the transfer belt is carbonized due to discharge and conductivity is thus increased or because low affinity between the resin (polyetherimide) and the conductive material brings about low dispersibility of the conductive material in the belt and the load caused by the discharge is localized.

Since elasticity of the belt is low while the variations in resistance may be prevented in the transfer belt using siloxane-modified polyeterimide as the thermoplastic resin, the belt is deformed during traveling, and the cleaning tends to be insufficient.

In contrast, the tubular body according to the exemplary embodiment includes a siloxane-modified polyetherimide and a polyetherimide except the siloxane-modified polyetherimide as thermoplastic resins, and the siloxane-modified polyetherimide occupies 40% or more of the entire polyetherimide components that are present at the surface layer portion. Therefore, carbonization tends not to occur during the discharge (carbonization tends not occur since the siloxane-modified polyetherimide has a siloxane structure). Since the siloxane-modified polyetherimide has a higher affinity with the conductive material such as carbon black as compared with polyetherimide, it becomes possible to highly disperse the conductive material and to prevent localization of the load caused by the discharge. Therefore, the decrease in resistance is prevented, and the resistance tends to be maintained by using the tubular body according to the exemplary embodiment as a transfer belt even if the particle diameters of the conductive material are relatively large.

In addition, the polyetherimide included in the tubular body according to the exemplary embodiment has higher elasticity as compared with the siloxane-modified polyetherimide and tends not to be deformed during the traveling. Therefore, it is possible to maintain the cleaning property.

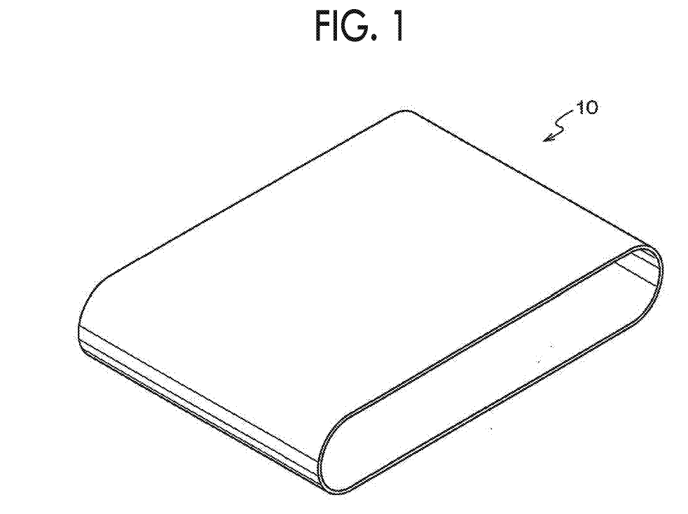

FIG. 1 is a perspective view schematically illustrating an example of the tubular member according to the exemplary embodiment. A tubular member 10 illustrated in FIG. 1 has a single-layer structure, which contains the siloxane-modified polyetherimide, the polyetherimide except the siloxane-modified polyetherimide, and a conductive material, in which the content of the siloxane-modified polyetherimide with respect to the total content of the siloxane-modified polyetherimide and the polyetherimide except the siloxane-modified polyetherimide at a surface layer portion is equal to or greater than 40% by weight. Hereinafter, description will be given of constituent materials of the tubular member 10 according to the exemplary embodiment. The tubular member will be referred to as a “tubular belt” in some cases.

### Polyetherimide Except Siloxane-Modified Polyetherimide

The polyetherimide except the siloxane-modified polyetherimide is a polyetherimide that does not include a siloxane bond and is, for example, a resin that contains an alicyclic or aromatic ether unit and a cyclic imide group as repeating units and has a melt-molding property.

Examples of polyetherimide include a resulting object obtained by a polymerization reaction between dicarboxylic dianhydride including ether bond and diamine. That is, examples of polyetherimide include polyetherimide that has at least a repeating unit structure derived from dicarboxylic dianhydride including ether bond and diamine, for example.

Examples of dicarboxylic dianhydride including ether bond includes 2,2-bis[4-(3,4-dicarboxyphenoxy)phenyl]propane dianhydride, 4,4′-bis(3,4-dicarboxyphenoxy)diphenylether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenyl sulfone dianhydride, 2,2-bis[4-(2,3-dicarboxyphenoxy)phenyl]propane dianhydride, 4,4′-bis(2,3-dicarboxyphenoxy)diphenylether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophe none dianhydride, and 4-(2,3-dicarboxyphenoxy)-4′-(3,4-dicarboxyphenoxy)diphenyl sulfone dianhydride. One kind of the above dicarboxylic dianhydride may be used alone, or two or more kinds selected therefrom may be used in combination.

Examples of diamine include aliphatic diamine, alicyclic diamine, aromatic diamine, and aromatic diamine including a heterocyclic ring.

Diamine is not particularly limited as long as diamine is a diamine compound including two amino groups in a molecular structure.

Examples of diamine include aromatic diamine such as p-phenylenediamine, m-phenylenediamine, 4,4′-diaminodiphenylmethane, 4,4′-diaminodiphenylethane, 4,4′-diaminodiphenylether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino 3′-trifluoromethylbenzanilide, 3,5-diamino 4′-trifluoromethylbenzanilide, 3,4′-diaminodiphenylether, 2,7-diaminofluorene, 2,2-bis(4-aminophenyl)hexafluoropropane, 4,4′-methylene-bis(2-chloraniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-bis[4-(4-amino-2-trifluoromethyl)phenoxy]-octafluorobiphenyl; aromatic diamine having two amino groups bonded to an aromatic group and a hetero atom besides the nitrogen atoms of the amino goups such as diamino tetraphenyl thiophene, aliphatic diamine and alicyclic diamine such as aromatic diamine 1,1-meta-xylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylenedimethyldiamine, tricyclo[6,2,1,0^{2.7}]-undecylenedimethyldimethyldiamine, 4,4′-methylenebis(cyclohexylamine). One kind of the above diamine may be used alone, or two or more kinds selected therefrom may be used in combination.

Polyetherimide except siloxane-modified polyetherimide included in the tubular member may be modified polyetherimide except siloxane-modified polyetherimide (such as cyano-modified polyetherimide or fluorine-containing polyetherimide), or unmodified polyetherimide is preferably used.

Commercially available polyetherimide may also be used, and examples thereof include ULTEM series such as ULTEM 1000, 1010, and 1100 manufactured by SABIC Innovative Plastics.

The content of polyetherimide in the entire tubular belt 10 according to the exemplary embodiment is preferably from 20 parts by weight to 70 parts by weight, more preferably from 25 parts by weight to 65 parts by weight, and further preferably from 30 parts by weight to 60 parts by weight with respect to 100 parts by weight of the entire resin components included in the tubular belt in terms of achieving both a surface resistance maintaining property and a cleaning maintaining property.

Here, the “entire resin” means the entire polyetherimide components in the case where the tubular belt contains only polyetherimide and siloxane-modified polyetherimide as resin components, and means resin components including polyetherimide, siloxane-modified polyetherimide, and other resin in a case where other resin is contained.

### Siloxane-Modified Polyetherimide

Siloxane-modified polyetherimide is polyetherimide that is obtained by modifying polyetherimide with silicone resin and has siloxane bond.

Specific examples of siloxane-modified polyetherimide include siloxane-modified polyetherimide obtained by modifying the polyetherimide with silicone resin, and for example, a reaction product of aromatic bis (ether anhydride), amine-terminated organosiloxane, and organic diamine is exemplified.

Examples of commercially available siloxane-modified polyetherimide (copolymer of polyetherimide resin and silicone resin) include SILTEM STM 1500, 1600, and 1700 manufactured by SABIC Innovative Plastics.

In the tubular belt according to the exemplary embodiment, the content of siloxane-modified polyetherimide is equal to or greater than 40% by weight with respect to the total content of siloxane-modified polyetherimide and polyetherimide except siloxane-modified polyetherimide at least at the surface layer portion. By setting the content of the siloxane-modified polyetherimide with respect to the entire polyetherimide components at the surface layer portion of the tubular belt to be equal to or greater than 40% by weight, both the surface resistance maintaining property and the cleaning maintaining property are achieved. There is a tendency that as the content of siloxane-modified polyetherimide increases with respect to the entire polyetherimide components at the surface layer portion of the tubular belt, the decrease in resistance is further prevented while elasticity decreases and the cleaning property is degraded. In terms of achieving both the surface resistance maintaining property and the cleaning maintaining property, the content of siloxane-modified polyetherimide with respect to the entire polyetherimide components at the surface layer portion of the tubular belt is preferably from 40% by weight to 75% by weight, and more preferably from 40% by weight to 70% by weight.

The surface layer portion of the tubular belt according to the exemplary embodiment may be within a thickness range from 1 μm to 10 μm from the surface (outer circumferential surface) of the tubular belt, for example.

The content of siloxane-modified polyeterimide with respect to the entire polyetherimide components at the surface layer portion of the tubular belt may be calculated by a method described in the example, which will be described later, by a Fourier transform infrared spectrometer (FTIR).

The content of siloxane-modified polyetherimide with respect the entire tubular belt 10 is preferably from 25 parts by weight to 75 parts by weight, and more preferably from 30 parts by weight to 70 parts by weight with respect to 100 parts by weight of entire resin included in the tubular belt in terms of achieving both the surface resistance maintaining property and the cleaning maintaining property.

### Conductive Material

Examples of the conductive material include carbon black; metal such as aluminum and nickel; metal oxides such as yttrium oxide and tin oxide; ion conductive materials such as potassium titanate and potassium chloride; and conductive polymer such as polyaniline, polypyrrol, polysulphone, and polyacetylene. From among these examples, carbon black is preferably used in terms of conductivity and economic efficiency. Carbon black exhibits excellent conductivity, and small content of carbon black may also apply high conductivity.

Examples of carbon black include Ketjen black, oil-furnace black, channel black, acetylene black and carbon black with oxidized surface (hereinafter, referred to as “surface-treated carbon black). From among these examples, the surface-treated carbon black is preferably used in terms of electric resistance stability over time.

The surface-treated carbon black is obtained by applying a carboxyl group, a quinone group, a lactone group, a hydroxyl group, or the like to the surface thereof. Examples of a method of the surface treatment includes an air oxidation method of bringing the carbon black into contact with the air in a high-temperature atmosphere and causing a reaction, a method of causing a reaction with nitrogen oxide or ozone at an ordinary temperature (22° C., for example), and a method of performing air oxidation in a high-temperature atmosphere and then oxidizing a resulting object with ozone at a low temperature.

An average primary particle diameter of the conductive material is preferably equal to or less than 50 nm, more preferably equal to or less than 30 nm, and particularly preferably equal to or less than 25 nm in terms of preventing surface resistivity of the tubular belt 10 from being degraded.

By setting the average primary particle diameter of the conductive material to be equal to or less than 30 nm, a state is obtained in which fine conductive points are achieved by the conducive material at the time of uniform dispersion, and a decrease in resistance due to degradation in discharge of the surface of the tubular belt 10 is easily prevented. A lower limit of the average primary particle diameter of the conductive material is equal to or greater than 10 nm, and preferably from equal to or greater than 15 nm, for example, in terms of aggregation force of carbon black.

The average primary particle diameter of the conductive material included in the tubular belt 10 according to the embodiment is measured by the following method.

First, a measurement sample having a thickness of 100 nm is collected from the obtained tubular belt 10 by a microtome, and the measurement sample is observed by a TEM (transmission electron microscope). Then, diameters of circles equivalent to projection areas of 50 conductive material particles (conductive particles) are regarded as particle diameters, and an average value thereof is regarded as the average primary particle diameter.

The content of the conductive material in the tubular belt 10 is preferably from 10 parts by weight to 30 parts by weight, more preferably from 12 parts by weight to 28 parts by weight, and further preferably from 15 parts by weight to 25 parts by weight with respect to 100 parts by weight of the entire resin, for example.

If the content of the conductive material in the tubular belt 10 is within the above range, density of the conductive points by the conductive material in the tubular belt 10 increases, and it becomes easier to disperse discharge energy received by the surface of the tubular belt 10. Therefore, degradation is prevented.

If the content of the conductive material is within the above range, the tubular belt 10 may easily obtain target conductivity and may easily form the conductive points at high density in the tubular belt 10. Although there is a concern about brittleness of the tubular belt 10 due to the blending of the conductive material, the tubular belt 10 according to the exemplary embodiment tends not to become brittle even if the content of the conductive material increases since siloxane-modified polyetherimide with a stretching property is contained.

The conductive material is preferably equal to or less than pH 5, more preferably equal to or less than pH 4.5, and further preferably equal to or less than pH 4.0 in terms of electric resistance stability over time.

### Silicon-Containing Particles

The tubular belt 10 according to the exemplary embodiment may contain silicon-containing particles. The silicon-containing particles is particles containing silicon, and specific examples thereof include silicone powder and silicone oil-containing silica.

The tubular belt 10 according to the exemplary embodiment containing the silicon-containing particles tends to have an enhanced cleaning property. Both the silicon-containing particles and siloxane-modified polyether imide contain Si, the silicon-containing particles exhibit a higher affinity for siloxane-modified polyetherimide than for polyetherimide. Therefore, if the tubular belt 10 according to the exemplary embodiment includes the silicon-containing particles, the silicon-containing particles tend to be localized in a region where siloxane-modified polyetherimide is present. It is considered that the localization of the silicon-containing particles in the region where siloxane-modified polyetherimide is present increases hardness of the siloxane-modified polyetherimide portion and enhances the cleaning property.

The average particle diameter of the silicon-containing particles that may be contained in the tubular belt 10 according to the exemplary embodiment is preferably from 50 nm to 15 μm, and more preferably from 100 nm to 10 μm.

Commercially available silicon-containing particles may also be used, and examples thereof include silicone powder manufactured by Shin-Etsu Chemical Co., Ltd. and silicone rubber powder manufactured by Dow Corning Toray Co., Ltd.

The content of the silicon-containing particles in the tubular belt 10 is preferably from 0.5 parts by weight to 20 parts by weight, more preferably from 1 part by weight to 10 parts by weight, and further preferably from 1 part by weight to 5 parts by weight with respect to 100 parts by weight of entire resin, for example.

By setting the average particle diameter and the content of the silicon-containing particles in the tubular belt 10 within the above ranges, it is possible to maintain the strength of the belt and enhances the cleaning property by increasing the hardness.

### Other Components

The tubular belt 10 according to the exemplary embodiment may contain components other than the above components.

Examples thereof include known additives to be blended in a tubular belt for an image forming apparatus, in particular, such as an antioxidant for preventing heat degradation of the tubular belt, a surfactant for enhancing fluidity, and a heat-resistant anti-aging agent.

The tubular belt 10 according to the exemplary embodiment may contain a thermoplastic resin (other resins) other than the polyetherimide and the siloxane-modified polyetherimide as long as both the surface resistance maintaining property and the cleaning maintaining property are achieved. In terms of achieving both the surface resistance maintaining property and the cleaning maintaining property and preventing a decrease in strength due to a decrease in solubility, the rate of the other resin with respect to the entirety of the resins contained is preferably equal to or less than 20% by weight, more preferably equal to or less than 10% by weight, and further preferably 0% by weight. That is, it is preferable that the total amount of polyetherimide and siloxane-modified polyetherimide occupies 100% by weight.

Next, description will be given of properties of the tubular belt 10 according to the exemplary embodiment.

The tubular belt 10 according to the exemplary embodiment preferably has a surface resistivity of 7 log Ω/square to 13 log Ω/square when measured by applying a voltage of 100 V in an environment at an ordinary temperature and ordinary humidity (temperature: 22° C., and humidity: 55% RH). In a case where the tubular belt 10 is applied as an intermediate transfer belt, in particular, the surface resistivity is preferably from 8 log Ω/square to 12 log Ω/square. If the tubular belt is applied as a transfer belt for transporting a recording medium, the surface resistivity is preferably from 9 log Ω/square to 13 log Ω/square.

The surface resistivity is a value measured by applying a voltage of 100 V in the environment at the ordinary temperature and the ordinary humidity (temperature: 22° C., and humidity: 55% RH).

In the tubular belt 10 according to the exemplary embodiment, a difference between surface resistivity measured by applying a voltage of 100 V in an environment at an ordinary temperature and ordinary humidity (temperature of 22° C. and humidity of 55% RH) and surface resistivity measured by applying a voltage of 1,000 V in the environment at the ordinary temperature and the ordinary humidity (temperature of 22° C. and humidity of 55% RH) is preferably equal to or less than 1.0 logΩ/square.

In the tubular belt 10 according to the exemplary embodiment, a difference between surface resistivity measured by applying a voltage of 100 V in an environment at a low temperature and a low humidity (temperature of 10° C. and humidity of 10% RH) and the surface resistivity measured by applying a voltage of 100 V in an environment at a high temperature and high humidity (temperature of 30° C. and humidity of 85% RH) is preferably equal to or less than 1.0 log Ω/square.

Here, as for the surface resistivity, a circular electrode (HIRESTA IP UR probe manufactured by Mitsubishi Petrochemical Co., Ltd, an outer diameter of a columnar electrode: φ16 mm, an inner diameter of ring-shaped electrode: φ30 mm, outer diameter: φ40 mm) is used, a measurement target is placed on an insulating plate, a target voltage is applied thereto in a target environment, a value of current flowing from the outer diameter to the inner diameter at 5 seconds after the application is measured by using a microammeter R8340A manufactured by Advantest Corporation, and the surface resistivity is obtained from a surface resistance value obtained from the current value based on JIS-K-6911 (1995).

The thickness of the tubular belt according to the exemplary embodiment is not particularly limited and may be selected in accordance with the purpose of use. In a case of using the tubular belt according to the exemplary embodiment as an intermediate transfer belt in an image forming apparatus, for example, the thickness thereof is preferably from 60 μm to 150 μm.

### Method of Preparing Tubular Member

A method of preparing the tubular member according to the exemplary embodiment is not particularly limited, and for example, it is preferable to prepare resin pellets that separately contain polyetherimide and siloxane-modified polyetherimide, to mix the respective resin pellets at a ratio in accordance with target surface resistivity, hardness, and the like, and to melt and extrude the mixture into a tubular shape.

For example, a resin pellet A obtained by blending and kneading predetermined amounts of polyetherimide, a conductive material, and if necessary, other components and a resin pellet B obtained by blending and kneading predetermined amounts of siloxane-modified polyetherimide, polyetherimide, a conductive material, or if necessary, other components are prepared. A twin-screw melt extruder is preferably used to prepare the respective resin pellets in terms of highly uniformly dispersing the conductive material in the resin.

Next, the obtained respective resin pellets A and B are put into the melt extruder to be melted and kneaded, are pushed out of the die into a tubular shape, and are cooled in a state where the outer circumferential surface of the cylindrical core contacts with the inner circumferential surface of the molten resin tubular member. If the respective pellets A and B are melt and pushed out of the die into the tubular shape by the melt extruder, polyetherimide has higher viscosity than that of siloxane-modified polyetherimide, and siloxane-modified polyetherimide tends to be localized at the surface layer portion.

The tubular belt may be obtained by cutting the obtained tubular member into a target length.

In a case of preparing a tubular belt containing silicon-containing particles, for example, the silicon-containing particles tend to be localized in the region where the siloxane-modified polyetherimide is present as described above and the cleaning property may easily be enhanced by blending the silicon-containing particles only in the resin pellet containing the siloxane-modified polyetherimide. In the case of preparing the tubular member by putting the respective resin particles A and B into the melt extruder, single-screw melt extruder that typically has lower kneading ability than that of the twin-screw melt extrude is preferably used in terms of localizing the silicon-containing particles in the region where the siloxane-modified polyetherimide is present.

It is possible to prepare a tubular material, which has a surface layer portion with an island-and-sea structure where one of polyetherimide and siloxane-modified polyetherimide corresponds to a sea and the other corresponds to an island, in which the silicon-containing particles are localized in the region where siloxane-modified polyetherimide is present by blending the two resin pellets respective containing different resins and melting and extruding the blended material into the tubular shape as described above.

Although the description was given of the tubular belt 10 configured as a single-layer member as an example of the tubular member according to the exemplary embodiment, the tubular member may be configured as a laminated member formed of two or more layers. Specifically, the tubular member according to the exemplary embodiment may be a tubular member, which is a laminated member formed of a base material layer and a surface layer laminated on the outer circumferential surface thereof, in which the surface layer contains siloxane-modified polyetherimide, polyetherimide except siloxane-modified polyetherimide, and a conductive material, in which the content of siloxane-modified polyetherimide with respect to the total content of entire polyetherimide components at the surface layer portion is equal to or greater than 40% by weight.

### Transfer Unit

The tubular belt 10 according to the exemplary embodiment may be preferably applied to a transfer belt (such as an intermediate transfer belt or a transfer belt for transporting a recording medium) for an image forming apparatus, for example.

A transfer unit according to the exemplary embodiment includes the transfer belt according to the exemplary embodiment and plural rolls over which the transfer belt is stretched in a tension applied state, and is detachable from an image forming apparatus.

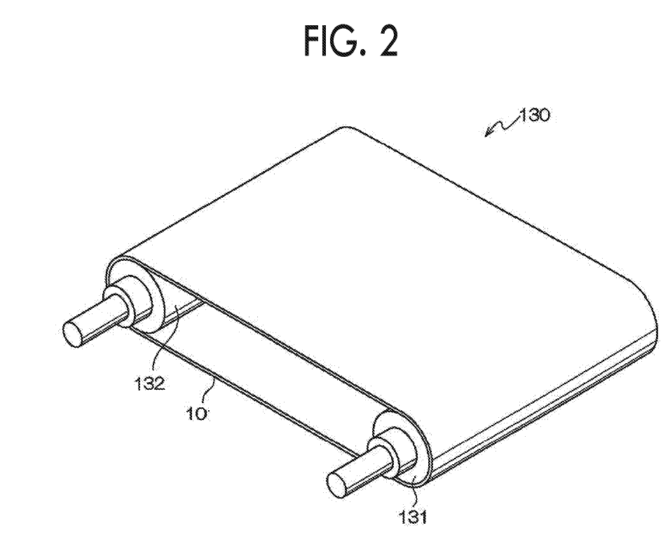

FIG. 2 is a perspective view schematically illustrating the transfer unit according to the exemplary embodiment. A transfer unit 130 according to the exemplary embodiment includes the tubular belt 10 according to the exemplary embodiment as a transfer belt, and for example, the tubular belt 10 is stretched (also referred to “extended” in some cases in the following description) in a state where tension is applied thereto by a driving roll 131 and a driven roll 132 arranged so as to face each other as illustrated in FIG. 2.

Here, in a case where the tubular belt 10 is applied as an intermediate transfer body (intermediate transfer belt) in the transfer unit 130 according to the exemplary embodiment, a roll for primarily transferring a toner image on the surface of a photoreceptor (image holding member) to the tubular belt 10 and a roll for further secondarily transferring the toner image transferred on the tubular belt 10 to a recording medium are arranged as rolls around which the tubular belt 10 is extended.

The number of rolls around which the tubular belt 10 is extended is not limited, and the rolls may be arranged in accordance with a use state. The transfer unit 130 with such a configuration is used while assembled in the apparatus, and rotates in a state where the tubular belt 10 is extended in association with rotation of the driving roll 131 and the driven roll 132.

### Image Forming Apparatus

The image forming apparatus according to the exemplary embodiment includes an image holding member, a charging unit that charges a surface of the image holding member, a latent image forming unit that forms a latent image on the charged surface of the image holding member, a developing unit that develops the latent image on the surface of the image holding member by using a toner and forms a toner image, the transfer belt according to the exemplary embodiment, a transfer unit that transfers the toner image formed on the surface of the image holding member to a recording medium, and a fixing unit that fixes the toner image transferred to the recording medium.

Specifically, a configuration of the image forming apparatus according to the exemplary embodiment is exemplified in which the transfer unit includes an intermediate transfer body, a primary transfer unit that primarily transfers a toner image formed on an image holding member to the intermediate transfer body, and a secondary transfer unit that secondarily transfers the toner image transferred to the intermediate transfer body to a recording medium and the tubular belt according to the exemplary embodiment is provided as the intermediate transfer body (intermediate transfer belt), for example.

In addition, a configuration of the image forming apparatus according to the exemplary embodiment is exemplified in which the transfer unit includes a transport transfer body (transport transfer belt) that transports a recoding medium and a transfer unit that transfers a toner image formed on an image holding member to a recording medium transported by a sheet transfer body and the tubular belt according to the exemplary embodiment is provided as the recording medium transfer body (transfer belt for transporting a recording medium).

Examples of the image forming apparatus according to the exemplary embodiment includes an ordinary mono-color image forming apparatus that accommodates only a single-color toner in a developing device, a color image forming apparatus that sequentially repeats primary transfer of a toner image held on an image holding member to an intermediate transfer body, and a tandem-type color image forming apparatus in which plural image holding members provided with developers of the respective colors are arranged in series on an intermediate transfer body.

Hereinafter, description will be given of the image forming apparatus according to the exemplary embodiment with reference to drawings.

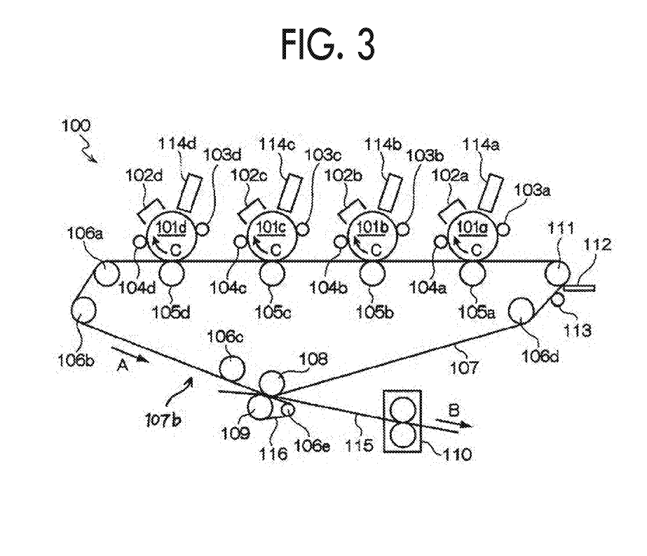

FIG. 3 is a configuration diagram schematically illustrating the image forming apparatus according to the exemplary embodiment.

An image forming apparatus 100 according to the exemplary embodiment is a so-called tandem-type image forming apparatus as illustrated in FIG. 3, and charging devices 102a to 102d, exposure devices 114a to 114d (an example of the latent image forming unit), developing devices 103a to 103d, primary transfer devices (primary transfer rolls) 105a to 105d, and image holding member cleaning devices 104a to 104d are arranged in this order in a circumference of four image holding members 101a to 101d formed of electrophotographic photoreceptors along a rotation direction thereof. In addition, an eraser for removing a potential remaining on the surfaces of the image holding members 101a to 101d after the transfer may be provided.

An intermediate transfer belt 107 is supported while support rolls 106a to 106d, a driving roll 111, and a facing roll 108 apply tension thereto, which forms a transfer unit 107b. The intermediate transfer belt 107 may move the respective image holding members 101a to 101d and the primary transfer rolls 105a to 105d in the direction of the arrow A while the intermediate transfer belt 107 contacts with the surfaces of the respective image holding members 101a to 101d by the support rolls 106a to 106d, the driving roll 111, and the facing roll 108. A portion at which the primary transfer rolls 105a to 105d contact with the image holding members 101a to 101d via the intermediate transfer belt 107 forms a primary transfer unit, and a primary transfer voltage is applied to the contact portion between the image holding members 101a to 101d and the primary transfer rolls 105a to 105d.

As a secondary transfer device, the facing roll 108 and a secondary transfer roll 109 are arranged so as to face each other via the intermediate transfer belt 107 and a secondary transfer belt 116. A recording medium 115 such as a paper moves in the direction of the arrow B in a region interposed between the intermediate transfer belt 107 and the secondary transfer roll 109 while the recording medium 115 contacts with the surface of the intermediate transfer belt 107, and then passes through a fixing device 110. A portion at which the secondary transfer roll 109 contacts with the facing roll 108 via the intermediate transfer belt 107 and the secondary transfer belt 116 forms a secondary transfer unit, and a secondary transfer voltage is applied to the contact portion between the secondary transfer roll 109 and the facing roll 108. Furthermore, intermediate transfer belt cleaning devices 112 and 113 are arranged so as to be brought into contact with the intermediate transfer belt 107 after the transfer.

In the multi-color image forming apparatus 100 with such a configuration, an electrostatic latent image of the first color is formed by the exposure device 114a that emits a laser beam, for example, after the image holding member 101a rotates in the direction of the arrow C and the surface thereof is charged by the charging device 102a. The formed electrostatic latent image is developed (visualized) with a toner by the developing device 103a that accommodates toners corresponding to the color, and a toner image is thus formed. The developing devices 103a to 103d accommodates toner (yellow, magenta, cyan, and black, for example) corresponding to electrostatic latent images of the respective colors.

The toner image formed on the image holding member 101a is electrostatically transferred (primarily transferred) to the intermediate transfer belt 107 by the primary transfer roll 105a when the toner image passes through the primary transfer unit. Thereafter, the primary transfer rolls 105b to 105d primarily transfer toner images of the second color, the third color, and the fourth color such that the toner images are sequentially superimposed on the intermediate transfer belt 107 holding the toner image of the first color, and a multi-color overlapped toner image is finally obtained.

The overlapped toner image formed on the intermediate transfer belt 107 is electrostatically and collectively transferred to the recording medium 115 when the overlapped toner image passes through the secondary transfer unit. The recording medium 115 on which the toner image has been transferred is transported to the fixing device 110, is subjected to fixing processing by being heated and pressurized, or heated or pressurized, and is then discharged to the outside of the apparatus.

The residual toners on the image holding members 101a to 101d after the primary transfer are removed by the image holding member cleaning devices 104a to 104d. In contrast, the residual toners on the intermediate transfer belt 107 after the secondary transfer are removed by the intermediate transfer belt cleaning devices 112 and 113 to prepare for a next image formation process.

### Image Holding Member

As the image holding members 101a to 101d, known electrophotographic photoreceptors are widely applied. As the electrophotographic photoreceptors, an inorganic photoreceptor in which a photosensitive layer is made of an inorganic material or an organic photoreceptor in which photosensitive layer is made of an organic material is used. As the organic photoreceptor, a function separate-type organic photoreceptor in which an electric charge generation layer for generating electric charge by exposure and a charge transport layer for transporting the electric charge are laminated or a single-layer organic photoreceptor that has both a function of generating electric charge and a function of transporting the electric charge is suitably used. As the inorganic photoreceptor, a photoreceptor in which a photosensitive layer is made of amorphous silicon is suitably used.

The shape of each image holding member is not particularly limited, and a known shape such as a cylindrical drum shape, a sheet shape, or a plate shape is employed.

### Charging Device

The charging devices 102a to 102d are not particularly limited, and a known charger such as a contact-type charge using a conductive (a “conductive” charging device described herein means that volume resistivity is less than 10⁷ Ω·cm, for example) or semiconductive (a “semiconductive” charging device means that the volume resistivity is from 10⁷ Ω·cm to 10¹³ Ω·cm, for example) roller, brush, film, rubber blade, or the like, or a scorotron charge or a corotron charge using corona discharge is widely used. From among these examples, the contact-type charge is preferably used.

Although the charging devices 102a to 102d ordinary apply a direct current to the image holding members 101a to 101d, the charging devices 102a to 102d may further apply an alternate current in a superimposed manner.

### Exposure Device

The exposure devices 114a to 114d are not particularly limited, and a known exposure device such as an optical device that may expose the surfaces of the image holding members 101a to 101d with alight source such as a semiconductor laser beam, a light emitting diode (LED) light, or liquid crystal shutter light, or via a polygon mirror from such a light source in accordance with a prescribed image is widely used.

### Developing Device

The developing devices 103a to 103d are selected in accordance with a purpose. Examples thereof include a known developing machine that develops an image with a single-component developer or a two-component developer by using a brush, a roller, or the like in a contact or non-contact manner.

### Primary Transfer Roll

The primary transfer rolls 105a to 105d may be any of single-layer rolls and multi-layer rolls. In a case of single-layer rolls, for example, the primary transfer rolls 105a to 105d are formed of rolls in which an appropriate amount of conductive particles such as carbon black are blended in foamed or non-foamed silicone rubber, urethane rubber, EPDM, or the like.

### Image Holding Member Cleaning Device

The image holding member cleaning devices 104a to 104d are for removing remaining toners that are attached to the surfaces of the image holding members 101a to 101d after the primary transfer process, and a cleaning blade, brush cleaning, roll cleaning, or the like is used. From among these examples, the cleaning blade is preferably used. Examples of a material of the cleaning blade includes urethane rubber, neoprene rubber, and silicone rubber.

### Secondary Transfer Roll

A layer structure of the secondary transfer roll 109 is not particularly limited, and in a case of a three-layer structure, for example, the layer structure thereof is formed of a core layer, an intermediate layer, and a coating layer that covers the surface thereof. The core layer is formed of a foamed body of silicone rubber, urethane rubber, EPDM, or the like in which conductive particles are dispersed, and the intermediate layer is formed of a non-foamed body of such a material. Examples of a material of the coating layer include tetrafluoroethylene-hexafluoropropylene copolymer and a perfluoroalkoxy resin. The volume resistivity of the secondary transfer roll 109 is preferably equal to or less than 10⁷ Ω·cm. Alternatively, a two-layer structure with the intermediate layer omitted may also be used.

### Facing Roll

The facing roll 108 forms a facing electrode of the secondary transfer roll 109. The facing roll 108 may have any of a single-layer structure and a multi-layer structure. In a case of a single-layer structure, for example, the facing roll 108 is formed of a roll in which an appropriate amount of conductive particles such as carbon black are blended in silicone rubber, urethane rubber, EPDM, or the like. In a case of a two-layer structure, the facing roll 108 is formed of a roll obtained by covering an outer circumferential surface of an elastic layer formed of the above rubber material with a high-resistant layer.

A voltage from 1 kV to 6 kV is typically applied to shafts of the facing roll 108 and the secondary transfer roll 109. The voltage may be applied to the electrode member with satisfactory electric conductivity, which contacts with the facing roll 108, and the secondary transfer roll 109 instead of the voltage application to the shaft to the facing roll 108. Examples of the electrode member include a metal roll, a conductive rubber roll, a conductive brush, a metal plate, and a conductive resin plate.

### Fixing Device

As the fixing device 110, a known fixer such as a heat roller fixer, a pressurizing roller fixer, or a flash fixer is widely used.

### Intermediate Transfer Belt Cleaning Device

As the intermediate transfer belt cleaning devices 112 and 113, a cleaning blade, brush cleaning, roll cleaning, or the like is used. From among these example, the cleaning blade is preferably used. Examples of a material of the cleaning blade include urethane rubber, neoprene rubber, and silicone rubber.

Although the tubular ember according to the exemplary embodiment and the transfer unit and the image forming apparatus using the tubular member according to the exemplary embodiment as a transfer belt were described above, the purpose of the tubular member according to the exemplary embodiment is not limited to the transfer belt. For example, the tubular member may be used as a conductive roll by covering an outer circumferential surface of a cylindrical elastic layer with the tubular member according to the exemplary embodiment.

### EXAMPLES

Although the exemplary embodiment of the invention is specifically described with reference to examples, the exemplary embodiment of the invention is not limited to these examples.

### Example 1

### Preparation of Resin Pellet A

15 parts by weight of a DENKA BLACK particle product (manufactured by Denka Company Ltd., average primary particle diameter: 35 nm) as a conductive material is blended with respect to 100 parts by weight of polyetherimide (ULTEM 1010 manufactured by SABIC Innovative Plastics) as a thermoplastic resin, and the mixture is melt and kneaded by using a twin-screw melt extrusion kneader (twin-screw melt kneading extruder L/D60 (manufactured by Parker Corporation, Inc.)). The kneaded molten substance is put into a water tank, is cooled, solidified, and then cut, thereby obtaining a mixed resin pellet A with carbon black blended in polyetherimide.

### Preparation of Resin Pellet B

17 parts by weight of DENKA BLACK is blended with respect to 100 parts by weight of siloxane-modified polyetherimide (SILTEM 1500 manufactured by SABIC Innovative Plastics) as a thermoplastic resin, and the mixture is melt and kneaded by using a twin-screw melt extrusion kneader (twin-screw melt kneading extruder L/D60 (manufactured by Parker Corporation, Inc.). The kneaded molten substance is put into a water tank, is cooled, solidified, and then cut, thereby obtaining a mixed resin pellet B with carbon black blended in siloxane-modified polyetherimide.

### Preparation of Tubular Belt

The resin pellets A and B obtained by the melting and kneading are mixed at a weight ratio of 1:1, and the mixture is put into a single-screw melt extruder (L/D24, melt extruder manufactured by Sanyou Seisakusho Co., Ltd.), and is melted and kneaded at a resin heating temperature of 320° C. at a screw rotation speed of 200 rpm. Then, the mixture is cooled while the outer circumferential surface of a cylindrical core contacts with the inner circumferential surface of a molten resin tubular member while the mixture is melt and extruded into a tubular shape from a clearance between a mold die and a nipple set at 300° C., and the tubular member is then cut, thereby obtaining a tubular belt 1 having a thickness of 100 μm.

### Evaluation

### Amount of Siloxane-Modified Polyetherimide Present on Surface

The amount of siloxane-modified polyetherimide that is present at the surface layer portion of the prepared tubular belt 1 is measured by an FTIR. Specifically, sample powder is collected from a region within a depth range from 1 μm to 5 μm from the surface by polishing the surface of the tubular belt with a file. An infrared absorption spectrum of the obtained sample is measured by using FT/IR-6100 (manufactured by JASCO Corporation), and a ratio (based on weight) of siloxane-modified polyetherimide that is present at the surface layer portion with respect to polyetherimide is estimated from a ratio of a peak derived from a siloxane skeleton of siloxane-modified polyetherimide with respect to a peak derived from a polyetherimide skeleton at the surface layer portion of the tubular belt.

### Surface Resistance Maintaining Property

The obtained tubular belt 1 is mounted as an intermediate transfer body on a DOCUPRINT CP200W manufactured by Fuji Xerox Co., Ltd., and 3000 halftone (magenta concentration of 30%) images are sequentially printed on A5 portrait sheets in a low-temperature low-humidity environment at 10° C. and 15% RH. A secondary transfer voltage at this time is set to 5.6 kV.

The surface resistivity (log Ω/square) of the tubular belt before and after the image printing is measured by an Advantest microammeter (UR probe; 100 V; 2 kg load; 5 seconds), and a difference between a common logarithm value of the surface resistivity before the printing and a common logarithm value of the surface resistivity after the printing is obtained. The difference is evaluated as a surface resistance maintaining property.

A variation in the surface resistivity ad the surface resistance maintaining property requires to be less than 0.6, and is preferably less than 0.3. Evaluation criteria are as follows.

A: The difference between the common logarithm values of the surface resistivity is less than 0.3.

B: The difference between the common logarithm values of the surface resistivity is equal to or greater than 0.3 and less than 0.6.

C: The difference between the common logarithm values of the surface resistivity is equal to or greater than 0.6.

### Cleaning Maintaining Property

The obtained tubular belt is mounted as an intermediate transfer body on a DOCUPRINT CP200W manufactured by Fuji Xerox Co., Ltd., and 10,000 total patterns including characters and patches are printed on C2/A4 sheets manufactured by Fuji Xerox Co., Ltd. in a low-temperature low-humidity environment at 10° C. and 15% RH. A secondary transfer voltage at this time is set to 5.6 kV. As the cleaning property, it is determined whether or not streak due to a cleaning failure is formed on the printed sheets.

A: No streak is formed (the number of sheets on which streak has occurred is zero).

B: Streak is formed, and the number of sheets on which the streak has occurred is less than five.

C: Streak is formed, and the number of sheets on which the streak has occurred is from 5 to 50.

### Example 2

A tubular belt 2 is obtained by the same procedure as in Example 1 except that a mixture ratio (based on weight) of the resin pellets A and B is set to 1:2 at the time of the melting and extruding the mixture in Example 1.

### Example 3

A tubular belt 3 is obtained by the same procedure as in Example 1 except that PRINTEX ALPHA (manufactured by Orion Engineered Carbons, average primary particle diameter: 20 nm) is used as carbon black in Example 1.

### Example 4

A tubular belt 4 is obtained by the same procedure as in Example 1 except that 5 parts by weight of silicone powder X52-854 (manufactured by Shin-Etsu Chemical Co., Ltd.) is blended with respect to 100 parts by weight of siloxane-modified polyetherimide at the time of preparing the resin pellet B in Example 1.

### Example 5

A tubular belt 5 is obtained by the same procedure as in Example 1 except that a mixture ratio (based on weight) of the resin pellets A and B is set to 1:4 at the time of the melting and extruding the mixture in Example 1.

### Comparative Example 1

A tubular belt C1 is obtained by the same procedure as in Example 1 except that the tubular body is prepared by using only the resin pellet A prepared in Example 1.

### Comparative Example 2

A tubular belt C2 is obtained by the same procedure as in Example 1 except that the tubular body is prepared by using only the resin pellet B prepared in Example 1.

### Comparative Example 3

A tubular belt C3 is obtained by the same procedure as in Example 1 except that a mixture ratio (based on weight) of the resin pellets A and B is set to 3:1 at the time of the melting and extruding the mixture in Example 1.

Main structures and evaluation results of the tubular belts prepared in the respective examples will be shown in Table 1. In the table, “PEI” is an abbreviation of “polyetherimide”.

TABLE 1

| | Average primary | | | Surface | |
|---|---|---|---|---|---|
| | particle | Presence of | Siloxane-modified | resistance | Cleaning |
| | diameter of | silicon-containing | PEI present ratio | maintaining | maintaining |
| | carbon black (nm) | particles blended | at surface (%) | property | property |
| Example 1 | 35 | Not present | 42 | B | B |
| Example 2 | 35 | Not present | 65 | B | B |
| Example 3 | 20 | Not present | 40 | A | B |
| Example 4 | 35 | Present | 42 | B | A |
| Example 5 | 35 | Not present | 80 | A | C |
| Comparative | 35 | Not present | 0 | C | B |
| Example 1 | | | | | |
| Comparative | 35 | Not present | 100 | A | — |
| Example 2 | | | | | |
| Comparative | 35 | Not present | 20 | C | B |
| Example 3 | | | | | |

In the case of forming images by using the tubular belt according to Comparative Example 2 as an intermediate transfer belt, elasticity of the belt is low, the belt is deformed during traveling, and a stable cleaning property cannot be achieved.

Based on the above results, it is possible to recognize that an excellent surface resistance maintaining property and an excellent cleaning maintaining property are achieved in the examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A tubular member comprising:
a siloxane-modified polyetherimide;
a polyetherimide except the siloxane-modified polyetherimide; and
a conductive material,
wherein a content of the siloxane-modified polyetherimide with respect to a total content of the siloxane-modified polyetherimide and the polyetherimide except the siloxane-modified polyetherimide at a surface layer portion is 40% by weight or more.

2. The tubular member according to claim 1, further comprising:
silicon-containing particles.

3. The tubular member according to claim 1,
wherein an average primary particle diameter of the conductive material is 30 nm or less.

4. The tubular member according to claim 2,
wherein an average primary particle diameter of the conductive material is 30 nm or less.

5. The tubular member according to claim 1,
wherein a content of the siloxane-modified polyetherimide with respect to the total content of the siloxane-modified polyetherimide and the polyetherimide except the siloxane-modified polyetherimide at the surface layer portion is 80% by weight or less.

6. The tubular member according to claim 2,
wherein a content of the siloxane-modified polyetherimide with respect to the total content of the siloxane-modified polyetherimide and the polyetherimide except the siloxane-modified polyetherimide at the surface layer portion is 80% by weight or less.

7. The tubular member according to claim 3,
wherein a content of the siloxane-modified polyetherimide with respect to the total content of the siloxane-modified polyetherimide and the polyetherimide except the siloxane-modified polyetherimide at the surface layer portion is 80% by weight or less.

8. The tubular member according to claim 4,
wherein a content of the siloxane-modified polyetherimide with respect to the total content of the siloxane-modified polyetherimide and the polyetherimide except the siloxane-modified polyetherimide at the surface layer portion is 80% by weight or less.

9. A transfer belt comprising:
the tubular member according to claim 1.

10. A transfer belt comprising:
the tubular member according to claim 2.

11. A transfer belt comprising:
the tubular member according to claim 3.

12. A transfer belt comprising:
the tubular member according to claim 4.

13. A transfer belt comprising:
the tubular member according to claim 5.

14. A transfer belt comprising:
the tubular member according to claim 6.

15. A transfer belt comprising:
the tubular member according to claim 7.

16. A transfer belt comprising:
the tubular member according to claim 8.

17. A transfer unit comprising:
the transfer belt according to claim 9; and
a plurality of rolls over which the transfer belt is stretched in a state where tension is applied thereto,
wherein the transfer unit is detachable from an image forming apparatus.

18. An image forming apparatus comprising:
an image holding member;
a charging unit that charges a surface of the image holding member;
a latent image forming unit that forms a latent image on a charged surface of the image holding member;
a developing unit that develops the latent image on the surface of the image holding member by using a toner to form a toner image;
a transfer unit that includes the transfer belt according to claim 9 and transfers the toner image formed on the surface of the image holding member to a recording medium; and
a fixing unit that fixes the toner image transferred to the recording medium.
